(19) United States
(12) Patent Application Publication
(10) Pub. No.: US 2026/0128509 A1
(43) Pub. Date: May 7, 2026

(54) Support for Wireless Communication Apparatus

(71) Applicant: KMW INC., Hwaseong-si (KR)

(72) Inventors: Dong Hee KIM, Pyeongtaek-si (KR); Dae Myung PARK, Hwaseong-si (KR); Hee KIM, Osan-si (KR); Jeoung Jun RYU, Anyang-si (KR); Ye Eun CHOI, Hwaseong-si (KR)

(73) Assignee: KMW INC., Hwaseong-si (KR)

(21) Appl. No.: 19/438,695

(22) Filed: Jan. 2, 2026

Related U.S. Application Data
(63) Continuation of application No. PCT/KR2024/008023, filed on Jun. 12, 2024.

(30) Foreign Application Priority Data
Jul. 5, 2023 (KR) 10-2023-0087168

(51) Int. Cl. H01Q 3/04

(52) U.S. Cl. CPC H01Q 3/04

(57) ABSTRACT

A supporter for a wireless communication apparatus is disclosed. At least one embodiment of the present disclosure provides a supporter for fixing a wireless communication apparatus to a support pole, the supporter including a fixing unit having one end fixed to the support pole, a body unit connected to an other end of the fixing unit and including a rotation unit rotated by a motor, a bracket unit that is connected to the rotation unit, rotatable about the rotation unit, and connected to the wireless communication apparatus, and an elastic member for absorbing shock, wherein the rotation unit has one side formed with a reception groove, the bracket unit has one side formed with a protrusion portion that is disposed inside the reception groove and conforms to the reception groove, and the elastic member is disposed between the reception groove and the protrusion portion.

### CROSS-REFERENCE TO RELATED APPLICATION

This application is a continuation application of International Application No. PCT/KR2024/008023, filed on Jun. 12, 2024, which claims the benefit of Korean Patent Applications No. 10-2023-0087168, filed on Jul. 5, 2023 in the Korean Intellectual Property Office, the disclosures of which are incorporated herein in their entirety by reference.

### TECHNICAL FIELD

The present disclosure relates to a support for a wireless communication apparatus.

### BACKGROUND

The statements in this section merely provide background information related to the present disclosure and do not necessarily constitute prior art.

Wireless communication devices such as antennas are typically placed on building rooftops or walls. This placement of antennas maximizes signal propagation range and minimizes interference between devices.

Multiple-input multiple-output (MIMO) technology applied in transceivers enhances data transmission performance by using multiple antennas. Increasing the number of transmit and receive antennas increases the channel capacity, enabling the transmission of more data. For example, increasing the number of antennas by a factor of 10 can provide approximately 10 times the channel capacity compared to using single antenna systems.

For a 4th Generation (4G) LTE-Advanced network, up to 8 antennas may be used. For a 5th Generation (5G) network, 64 or 128 antennas may be employed. Thus, the number of antennas used is trending upward with the commercialization of the 5G network and advancements in communication technology.

As the number of antennas increases in Massive MIMO technology, the number of transmitters and filters also increases. When installing MIMO antennas, which are modules with radio frequency (RF) components and digital components arranged in a stacked structure, within a limited space, miniaturization of the MIMO antenna is required to maximize installation ease and space utilization.

Wireless communication apparatus have suitable angles and arrangements for transmitting and receiving wireless signals. For example, for an antenna installation on a support pole, a supporter for wireless communication apparatus may be used to adjust the antennas'position and direction. The supporter for wireless communication apparatus includes a portion for installing the wireless communication apparatus and a portion fixed to the support pole. The supporter for wireless communication apparatus may include a joint portion for adjusting the position and direction of the wireless communication apparatus, and this joint portion is susceptible to damages from repeated use. A method is required for the supporter for wireless communication apparatus to absorb or dissipate the impact occurring at the joint portion.

### DISCLOSURE

### Technical Problem

The present disclosure seeks to address the above issues by providing a supporter for installing a wireless communication apparatus on a support pole.

Furthermore, the present disclosure seeks to provide a supporter capable of adjusting the position and orientation of the wireless communication apparatus.

Additionally, the present disclosure seeks to provide a method of absorbing or dissipating shocks occurring at the joint portion of the supporter.

### SUMMARY

According to at least one embodiment, the present disclosure provides a supporter for fixing a wireless communication apparatus to a support pole, the supporter including a fixing unit having one end fixed to the support pole, a body unit connected to an other end of the fixing unit and including a rotation unit rotated by a motor, a bracket unit that is connected to the rotation unit, rotatable about the rotation unit, and connected to the wireless communication apparatus, and an elastic member configured to absorb shock, wherein the rotation unit has one side formed with a reception groove, the bracket unit has one side formed with a protrusion portion that is disposed inside the reception groove and conforms to the reception groove, and the elastic member is disposed between the reception groove and the protrusion portion.

According to another embodiment, the present disclosure provides a supporter for a wireless communication apparatus to a pole, the supporter including a fixing unit having one end fixed to the pole, a body unit connected to an other end of the fixing unit and including a rotation unit rotated by a motor, a bracket unit that is connected to the rotation unit, rotatable about the rotation unit, and connected to the wireless communication apparatus, elastic rings disposed inside the bracket unit and configured to absorb shock, and bolts penetrating the bracket unit and the elastic rings, wherein the rotation unit has one side formed with cradling portions, the bracket unit has one side formed with sliding portions that conform to the cradling portions and are disposed on the cradling portions, and the bolts are screw-coupled with the rotation unit.

### Advantageous Effects

As described above, according to embodiments of the present disclosure, the supporter for wireless communication apparatus has the effect of enabling the wireless communication apparatus to be installed on a support pole.

Furthermore, the present disclosure has the effect of enabling the position and orientation of the wireless communication apparatus to be adjusted.

Additionally, the present disclosure has the effect of dissipating the impact generated at a rotation unit and a bracket unit of the supporter for wireless communication apparatus.

### BRIEF DESCRIPTION OF THE DRAWINGS

FIG. 1 is a perspective view of a supporter for wireless communication apparatus according to the first embodiment of the present disclosure.

FIG. 2 is an exploded perspective view of the supporter for wireless communication apparatus according to the first embodiment of the present disclosure.

FIG. 3 is a perspective view of a rotation unit according to the first embodiment of the present disclosure.

FIG. 4 is a cross-sectional view of the supporter for wireless communication apparatus according to the first embodiment of the present disclosure.

FIG. 5 is a perspective view of a supporter for wireless communication apparatus according to the second embodiment of the present disclosure.

FIG. 6 is an exploded perspective view of the supporter for wireless communication apparatus according to the second embodiment of the present disclosure.

FIG. 7 is a perspective view of a rotation unit according to the second embodiment of the present disclosure.

FIG. 8 is a cross-sectional view of the supporter for wireless communication apparatus according to the second embodiment of the present disclosure.

FIG. 9A and FIG. 9B illustrate the movement of a sliding portion according to the second embodiment of the present disclosure.

### DETAILED DESCRIPTION

Hereinafter, some embodiments of the present disclosure will be described in detail with reference to the accompanying illustrative drawings. In the following description, like reference numerals preferably designate like elements, although the elements are shown in different drawings. Further, in the following description of some embodiments, a detailed description of related known components and functions when considered to obscure the subject of the present disclosure will be omitted for the purpose of clarity and for brevity.

Various ordinal numbers or alpha codes, such as first, second, i), ii), a), b), etc., are prefixed to describe the components of embodiments of the present disclosure. They are used solely to differentiate one component from the other but not to imply or suggest the substances, order, or sequence of the components.

When components are described as ‘connected’, ‘coupled’, or ‘linked’ to another component, they are meant to not only directly ‘connected’, ‘coupled’, or ‘linked’ but also to indirectly ‘connected’, ‘coupled’, or ‘linked’ via one or more additional components.

Throughout this specification, when a part ‘includes’ or ‘comprises’ a component, the part is meant to further include other components, to not exclude thereof unless specifically stated to the contrary.

The terms such as ‘unit’, ‘module’, and the like refer to units for processing at least one function or operation, which may be implemented by hardware, software, or a combination thereof.

Unless the contrary is indicated, the description of any one of embodiments is intended to apply to other embodiments.

The description of the present disclosure to be presented below in conjunction with the accompanying drawings is intended to describe exemplary embodiments of the present disclosure and is not intended to represent the only embodiments in which the technical idea of the present disclosure may be practiced.

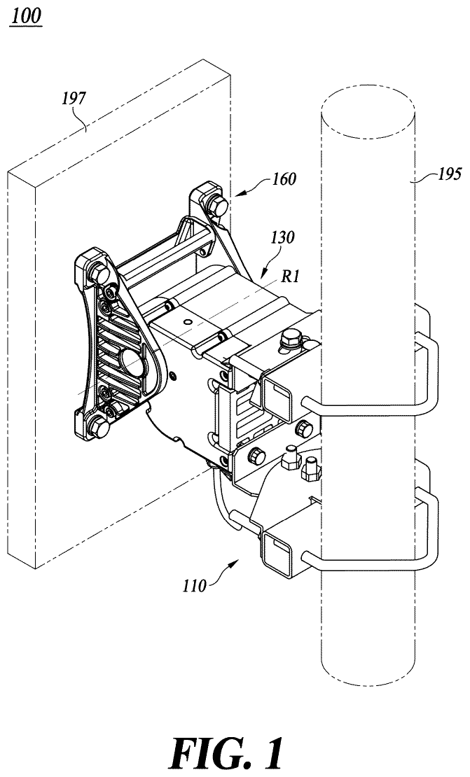

FIG. 1 is a perspective view of a supporter for wireless communication apparatus according to the first embodiment of the present disclosure.

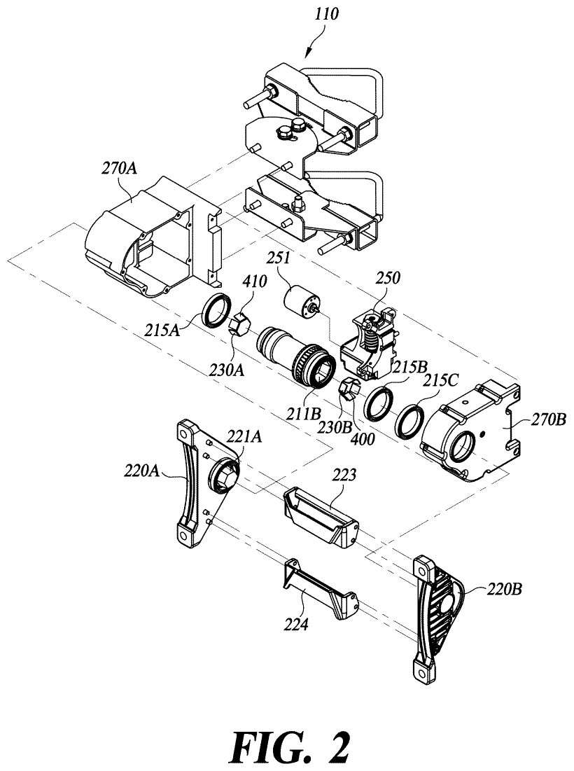

FIG. 2 is an exploded perspective view of the supporter for wireless communication apparatus according to the first embodiment of the present disclosure.

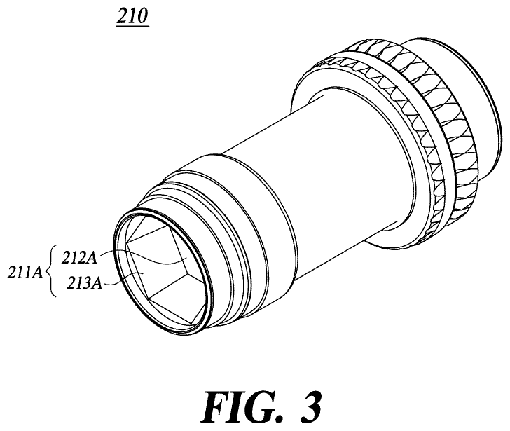

FIG. 3 is a perspective view of a rotation unit according to the first embodiment of the present disclosure.

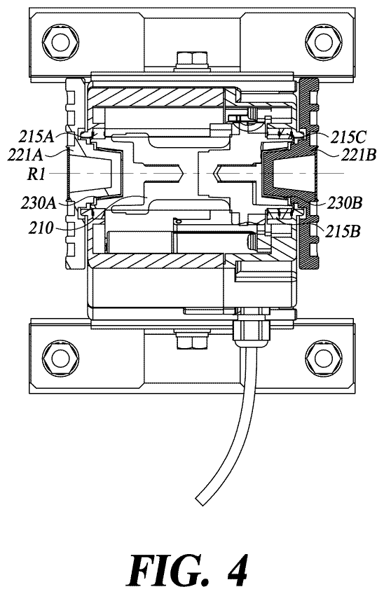

FIG. 4 is a cross-sectional view of the supporter for wireless communication apparatus according to the first embodiment of the present disclosure.

Referring to FIG. 1 through FIG. 4, a supporter 100 for a wireless communication apparatus according to the first embodiment of the present disclosure is fixed in position by being coupled to a support pole 195. To one side of the supporter 100, a wireless communication apparatus 197 is coupled. The supporter 100 may adjust the position and angle of the wireless communication apparatus 197 by including a rotation unit 210 to be detailed below. The supporter 100 may absorb shock by including elastic members 230 detailed below.

The supporter 100 may include a fixing unit 110, a body unit 130, a bracket unit 160, and a plurality of elastic members 230.

The fixing unit 110 may have one end coupled to the support pole 195. The other end of the fixing unit 110 may be coupled to the body unit 130. The fixing unit 110 may be positioned between the support pole 195 and the body unit 130. The fixing unit 110 may serve to interconnect the support pole 195 and the body unit 130. The shape of the fixing unit 110 is not limited to what is disclosed in the drawings. The shape of the fixing unit 110 may encompass any shape capable of being coupled to the support pole 195. The shape of the fixing unit 110 may encompass any shape capable of being coupled to the body unit 130.

The body unit 130 serves to rotate the bracket unit 160 as detailed below. The body unit 130 may be coupled to the fixing unit 110. The body unit 130 may be coupled to the bracket unit 160. The body unit 130 may include housing parts 270 (270A and 270B), a plurality of ring members 215 (215A-215C), a rotation unit 210, a motor 251, and a gearbox 250.

The housing parts 270 form the exterior of the body unit 130. The housing parts 270 may accommodate multiple components internally. The housing parts 270 may include a first housing part 270A and a second housing part 270B. The first housing part 270A and the second housing part 270B may have different shapes. The shapes of the housing parts 270 are not limited to those disclosed in the drawings.

The motor 251 is disposed inside the housing parts 270. The motor 251 provides power to rotate the rotation unit 210. The motor 251 transmits power to the gearbox 250, and the gearbox 250 rotates the rotation unit 210. The gearbox 250 may include a plurality of worm and worm gears. The gearbox 250 contacts the rotation unit 210.

A plurality of ring members 215 may be arranged to surround the outer circumferential surfaces of the rotation unit 210. The plurality of ring members 215 may support the rotation unit 210. The plurality of ring members 215 assist in the rotation of the rotation unit 210. According to at least one embodiment, the plurality of ring members 215 may include a first ring member 215A through a third ring member 215C. The shape and arrangement of the plurality of ring members 215 are not limited to those disclosed in the drawings.

The rotation unit 210 may be linked with the bracket unit 160. In particular, reception grooves 211 formed in the rotation unit 210 may engage protrusion portions 221 formed in the bracket unit 160. The reception grooves 211 and protrusion portions 221 will be described below.

The rotation unit 210 may rotate the bracket unit 160. The rotation unit 210 may be rotated by the motor 251. The rotation unit 210 rotates about an axis-of-rotation R1. The rotation unit 210 is disposed inside the housing parts 270. The arrangement and shape of the rotation unit 210 are not limited by the disclosure in the drawings.

The rotation unit 210 may include the reception grooves 211 formed on one side. The reception grooves 211 may be located at both ends of the rotation unit 210. The rotation unit 210 may include a plurality of reception grooves 211. The reception grooves 211 may conform to the protrusion portions 221 and/or elastic members 230 described below. The reception grooves 211 may include first surfaces 212 in a central portion. The first surfaces 212 may be a plane perpendicular to the axis-of-rotation R1. The reception grooves 211 may include a plurality of inner circumferential surfaces 213. The plurality of inner circumferential surfaces 213 may be formed inclined relative to the axis-of-rotation R1. In this case, the plurality of inner circumferential surfaces 213 may have a constant inclination.

The rotation unit 210 may include a first reception groove 211A at one end and a second reception groove 211B at the other end. The first reception groove 211A and the second reception groove 211B may have the same shape.

The elastic members 230 and protrusion portions 221 may be disposed inside the reception grooves 211. In this case, the elastic members 230 may be disposed between the reception grooves 211 and the protrusion portions 221.

The bracket unit 160 may be coupled to the body unit 130. The bracket unit 160 may be coupled to the wireless communication apparatus 197. The bracket unit 160 may rotate about the rotation unit 210. The bracket unit 160 rotates upon receiving power from the rotation unit 210. The bracket unit 160 when rotating changes the position and angle of the wireless communication apparatus 197 coupled to the bracket unit 160. The shape of the bracket unit 160 is not limited to that shown in the drawings.

The bracket unit 160 may include a plurality of rotation plates 220 rotated by the rotation unit 210. The plurality of rotation plates 220 may include a first rotation plate 220A and a second rotation plate 220B. The bracket unit 160 may include a first support member 223 and a second support member 224. The bracket unit 160 may include a first support member 223 and a second support member 224. The first support member 223 and the second support member 224 may be disposed between the first rotation plate 220A and the second rotation plate 220B. The shape of the first support member 223 and the second support member 224 is not limited to that shown in the drawings.

The bracket unit 160 may include at least one protrusion portion 221 formed on at least one side thereof. The protrusion portion 221 may be formed extending from one of the rotation plates 220 toward the rotation unit 210. The bracket unit 160 may include a plurality of protrusion portions 221. The plurality of protrusion portions 221 may include a pair of protrusion portions 221. For example, the first rotation plate 220A may include a first protrusion portion 221A. The second rotation plate 220B may include a second protrusion portion 221B. The first protrusion portion 221A is positioned inside the first reception groove 211A. The second protrusion portion 221B is disposed inside the second reception groove 211B. Thus, when a plurality of protrusion portions 221 includes a pair of protrusion portions 221, they may have identical shapes. The protrusion portions 221 of the pair are positioned on the same line as the axis-of-rotation R1. The protrusion portions 221 may each rotate about the axis-of-rotation R1.

The protrusion portions 221 are disposed on the inner side of the reception grooves 211 and elastic members 230. The protrusion portions 221 may conform to the reception grooves 211 and/or the elastic members 230. For example, the first protrusion portion 221A may conform to the first reception groove 211A and/or the first elastic member 230A. The second protrusion portion 221B may conform to the second reception groove 211B and/or the second elastic member 230B.

The protrusion portions 221 may include a hexagonal column. In this case, the elastic members 230 and/or the reception grooves 211 may conform to the hexagonal column.

The outer circumferential surfaces forming the hexagonal column may be formed to be inclined relative to the axis-of-rotation R1. In this case, the outer circumferential surfaces may have a constant inclination. For example, the area of a cross-section perpendicular to the lengthwise direction of the hexagonal column may increase or decrease linearly along the lengthwise direction.

The elastic members 230 may each be disposed on one side of the rotation unit 210. The elastic members 230 may be plural. For example, the elastic members 230 may include a first elastic member 230A and a second elastic member 230B. The first elastic member 230A and the second elastic member 230B may have the same shape. The elastic members 230 are positioned between the reception grooves 211 and the protrusion portions 221. For example, the first elastic member 230A may be positioned between the first reception groove 211A and the first protrusion portion 221A. The second elastic member 230B may be positioned between the second reception groove 211B and the second protrusion portion 221B.

The elastic members 230 absorb impacts caused by external forces. The elastic members 230 may be elastically deformed by the reception grooves 211. The elastic members 230 may be larger in size than the inner space of the reception grooves 211.

When an external force acts on the supporter 100, the first protrusion portion 221A and/or the second protrusion portion 221B may move. For example, the protrusion portions 221 may move up, down, left, or right within the inner space of the elastic members 230.

With an external force applied, the elastic members 230 undergo elastic deformation. The elastic members 230 absorb the impact to prevent damage to the protrusion portions 221 and the rotation unit 210.

When relieved of the external force, the first protrusion portion 221A and/or the second protrusion portion 221B return to their original positions due to the elastic force of the first elastic member 230A and/or the second elastic member 230B. Here, the original position refers to the position before the external force was applied. When the first protrusion portion 221A and/or the second protrusion portion 221B return to their original positions, the elastic members 230 also recover their original shapes.

The first elastic member 230A and the second elastic member 230B may have identical shapes. The elastic members 230 may have one surface 400 conforming to the protrusion portions 221. For example, when the protrusion portions 221 include hexagonal columns, one surface 400 of the elastic members 230 may have a hexagonal shape conforming to the hexagonal columns.

The elastic members 230 may include a plurality of extension portions 410. The plurality of extension portions 410 may be formed extending from the one surface 400 of the elastic members 230. The plurality of extension portions 410 may include a first extension portion through a sixth extension portion.

The multiple extension portions 410 may each be formed to have an outer circumferential surface and an inner circumferential surface that is longer than the outer circumferential surface. In this case, due to the difference in length between the inner circumferential surface and the outer circumferential surface, each of the multiple extension portions 410 may have a curved shape along the lengthwise direction. The multiple extension portions 410 may be formed to have no mutually contacting portions.

The multiple extension portions 410 may be elastically deformed by the reception grooves 211. In particular, when the size of the multiple extension portions 410 is larger than the space of the reception grooves 211, the multiple extension portions 410 may be inserted into the reception grooves 211 in an elastically deformed state.

The elastic members 230 may be manufactured by using a metallic material. The first elastic member 230A and the second elastic member 230B may be made of the same metallic material.

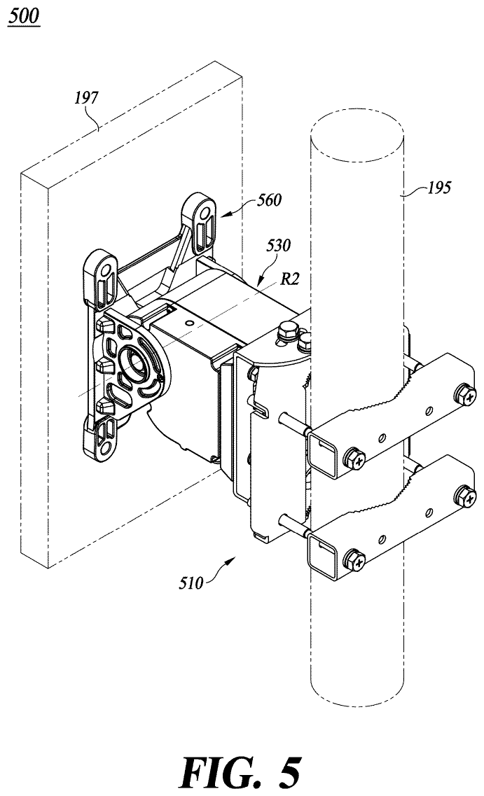

FIG. 5 is a perspective view of a supporter for wireless communication apparatus according to the second embodiment of the present disclosure.

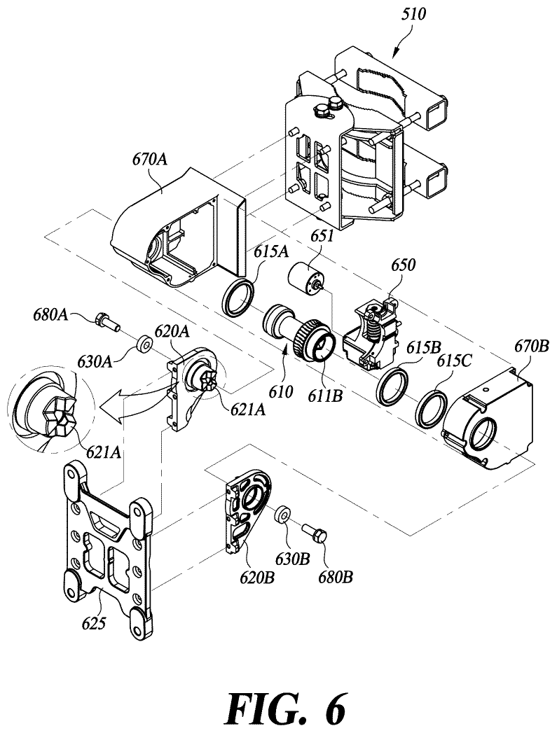

FIG. 6 is an exploded perspective view of the supporter for wireless communication apparatus according to the second embodiment of the present disclosure.

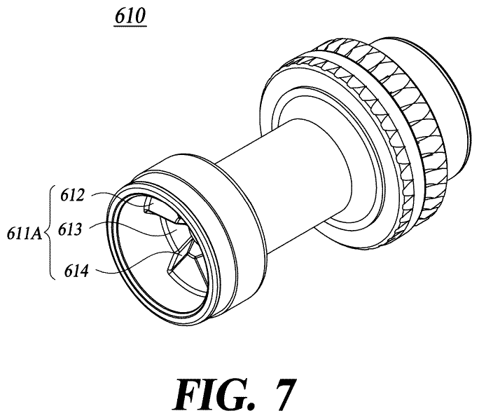

FIG. 7 is a perspective view of a rotation unit according to the second embodiment of the present disclosure.

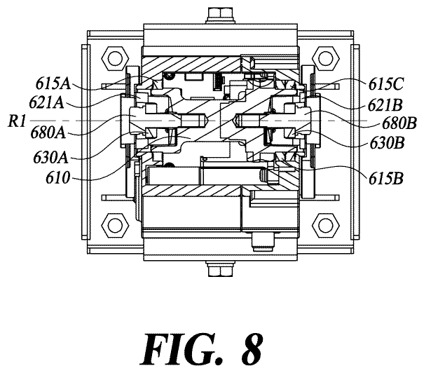

FIG. 8 is a cross-sectional view of the supporter for wireless communication apparatus according to the second embodiment of the present disclosure.

Referring to FIG. 5 through FIG. 8, a supporter 500 for a wireless communication apparatus according to the second embodiment of the present disclosure is fixed in position by being coupled to a support pole 195. A wireless communication apparatus 197 is coupled to one side of the supporter 500. The supporter 500 includes a rotation unit 610 to adjust the position and angle of the wireless communication apparatus 197. The supporter 500 includes elastic rings 630, described below, to absorb shock.

The supporter 500 may include a fixing unit 510, a body unit 530, a bracket unit 560, a plurality of elastic rings 630, and a plurality of bolts 680.

The fixing unit 510 may have one end coupled to the support pole 195. The other end of the fixing unit 510 may be coupled to the body unit 530. The fixing unit 510 may be positioned between the support pole 195 and the body unit 530. The fixing unit 510 may serve to interconnect the support pole 195 and the body unit 530. The shape of the fixing unit 510 is not limited to what is disclosed in the drawings. The shape of the fixing unit 510 may encompass any shape capable of being coupled to the support pole 195. The shape of the fixing unit 510 may encompass any shape capable of being coupled with the body unit 530.

The body unit 530 serves to rotate the bracket unit 560. The body unit 530 may be coupled with the fixing unit 510. The body unit 530 may be coupled to the bracket unit 560. The body unit 530 may include housing parts 670, a plurality of ring members 815, a rotation unit 610, a motor 651, and a gearbox 650.

For the description of the housing parts 670, multiple ring members 815, motor 651, and gearbox 650 according to the second embodiment of the present disclosure, reference can be made to the above description of the housing parts 270, multiple ring members 215, motor 251, and gearbox 250 according to the first embodiment.

The rotation unit 610 may be interconnected with the bracket unit 560. In particular, cradling portions 611 formed on the rotation unit 610 may be interconnected with sliding portions 621 formed on the bracket unit 560. The cradling portions 611 and sliding portions 621 will be described below.

The rotation unit 610 may rotate the bracket unit 560. The rotation unit 610 may rotate via the motor 651. The rotation unit 610 rotates about an axis-of-rotation R2. The rotation unit 610 is disposed within the housing parts 670. The arrangement and configuration of the rotation unit 610 are not limited by the disclosure in the drawings.

The rotation unit 610 may be formed with cradling portions 611 on either sides thereof. The cradling portions 611 may be located at both ends of the rotation unit 610. The rotation unit 610 may include a plurality of cradling portions 611. The rotation unit 610 may include a first cradling portion 611A and a second cradling portion 611B. The cradling portions 611 may conform to the sliding portions 621 described below. For example, the first cradling portion 611A may conform to a first sliding portion 621A. The second cradling portion 611B may conform to a second sliding portion 621B. The shapes of the first cradling portion 611A and the second cradling portion 611B may be identical to each other. Bolts 680 may be screw-coupled with the cradling portions 611.

The cradling portions 611 may each include a plurality of slopes 614, a plurality of first surfaces 612, a plurality of second surfaces 613, and a hole 616.

The slopes 614 may form a constant angle relative to the axis-of-rotation R2. The cradling portions 611 may include a first slope through a sixth slope. The slope 614 are positioned between first surfaces 612 and second surfaces 613, respectively.

A height difference exists between the first surfaces 612 and the second surfaces 613. The first surfaces 612 and the second surfaces 613 may be perpendicular to the axis-of-rotation R2. The cradling portions 611 may include three first surfaces 612. The cradling portions 611 may include three second surfaces 613. The sliding portions 621, described below, may slide along at least one of the slopes 614.

The hole 616 is formed centrally of the cradling portions 611. The center axis of the hole 616 may coincide with the axis-of-rotation R2. The hole 616 may be a screw hole. The rotation unit 610 may be screw-coupled with a first bolt 680A or a second bolt 680B, described below, by using the hole 616.

The bolts 680 may be coupled to the cradling portions 611. The supporter 500 may include a plurality of bolts 680. The supporter 500 may include the first bolt 680A and the second bolt 680B. In this case, the first bolt 680A may be screw-coupled with the first cradling portion 611A. The second bolt 680B may be screw-coupled with the second cradling portion 611B.

The bolts 680 may pass through the elastic rings 630 described below. The bolts 680 may pass through the sliding portions 621 described below. The bolts 680, while passing through the elastic rings 630 and sliding portions 621, may be screw-coupled with the cradling portions 611.

The bracket unit 560 may be coupled to the body unit 530. The bracket unit 560 may be coupled to the wireless communication apparatus 197. The bracket unit 560 may rotate about the rotation unit 610. The bracket unit 560 rotates upon receiving power from the rotation unit 610. The bracket unit 560 when rotating changes the position and angle of the wireless communication apparatus 197 coupled to the bracket unit 560. The shape of the bracket unit 560 is not limited to that shown in the drawings.

The bracket unit 560 may include a plurality of rotation plates 620 rotated by the rotation unit 210. The bracket unit 560 may include a first rotation plate 620A and a second rotation plate 620B. The bracket unit 560 may include a support plate 625. The support plate 625 may be positioned between the first sliding portion 621A and the second sliding portion 621B. The shape of the support plate 625 is not limited to that shown in the drawings.

The bracket unit 560 includes sliding portions 621 formed on either sides. The sliding portions 621 may rotate by receiving power from the cradling portions 611. The sliding portions 621 may be formed extending from one side of the rotation plates 620 toward the rotation unit 610. The bracket unit 560 may include the first sliding portion 621A and the second sliding portion 621B. The first sliding portion 621A is positioned on the first cradling portion 611A. The second sliding portion 621B is positioned on the second cradling portion 611B.

The sliding portions 621 may conform to the cradling portions 611. For example, the first sliding portion 621A may conform to the first cradling portion 611A. The second sliding portion 621B may conform to the second cradling portion 611B.

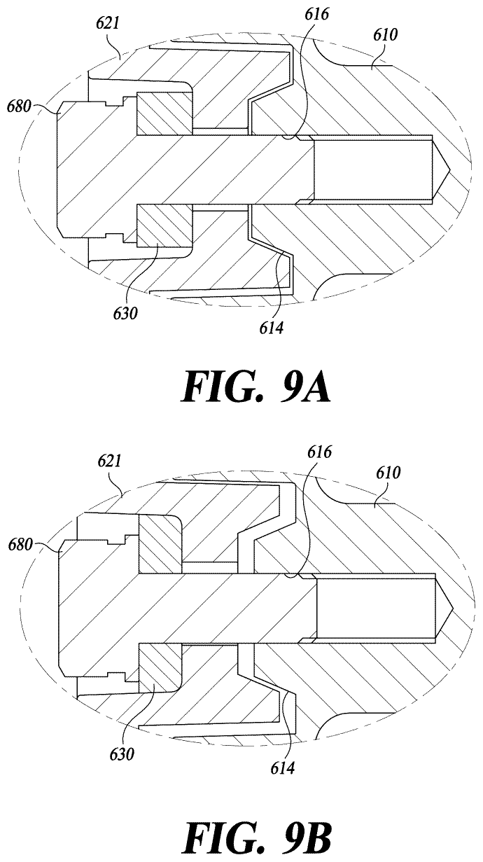

FIG. 9A and FIG. 9B illustrate the movement of a sliding portion according to the second embodiment of the present disclosure.

FIG. 9A shows the sliding portions and elastic rings before an external force is applied, and FIG. 9B shows the sliding portions and elastic rings after an external force is applied.

Referring to FIG. 5 through FIG. 9B, the sliding portions 621 may slide along a plurality of slopes 614 formed in the cradling portions 611. The shape and number of slopes 614 are not limited to those shown in the drawings. For example, when an external force acts, the sliding portions 621 may move along the slopes 614. When the sliding portions 621 move, the elastic rings 630 may undergo elastic deformation. In particular, the bolts 680 and the rotation unit 610 are fixed to each other by a screw coupling and therefore do not change position. The sliding portions 621, not being screw-coupled, may move up, down, left, and right between the elastic rings 630 and the rotation unit 610. The sliding portions 621 may move along the slopes 614 of the cradling portions 611. Referring to FIG. 9B, the sliding portions 621 are shown moving from their original position, causing the elastic rings 630 to undergo elastic deformation.

The wireless communication apparatus'supporter 500 may include a plurality of elastic rings 630. The wireless communication apparatus'supporter 500 may include a first elastic ring 630A and a second elastic ring 630B. The elastic rings 630 may be penetrated by the bolts 680. The elastic rings 630 may be positioned on the inner side of the sliding portions 621. The elastic rings 630 may be positioned between the bolts 680 and the sliding portions 621. For example, the first elastic ring 630A is positioned between the first bolt 680A and the first sliding portion 621A. The second elastic ring 630B is positioned between the second bolt 680B and the second sliding portion 621B.

The elastic rings 630 absorb impacts caused by external forces. The elastic rings 630 may undergo elastic deformation when the sliding portions 621 move. The first sliding portion 621A and/or the second sliding portion 621B may move due to external forces. In particular, the sliding portions 621 may move along the slopes 614 formed in the cradling portions 611. In this case, the elastic rings 630 undergo elastic deformation. The elastic rings 630 absorb impact to prevent the sliding portions 621 from breaking.

When relieved from external force, the first sliding portion 621A and/or the second sliding portion 621B return to their original positions due to the elastic force of the first elastic ring 630A and/or the second elastic ring 630B. Here, the original position refers to the position before the external force was applied. When the first sliding portion 621A and/or the second sliding portion 621B return to their original positions, the elastic rings 630 also recover their original shapes.

The elastic rings 630 may be cylindrical in shape with a hole formed in the center. The first elastic ring 630A and the second elastic ring 630B may have identical shapes.

The elastic rings 630 may be made of rubber material. The first elastic ring 630A and the second elastic ring 630B may be made of rubber of the same material quality.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the embodiments of the present disclosure is not limited by the illustrations. Accordingly, one of ordinary skill would understand the scope of the claimed invention is not to be limited by the above explicitly described embodiments but by the claims and equivalents thereof.′

### REFERENCE NUMERALS

100: wireless communication apparatus'supporter
110: fixing unit
130: body unit
160: bracket unit
210: rotation unit
211: reception groove
212: first surface
213: inner circumferential surface
215: ring member
220: rotation plate
221: protrusion portion
230: elastic member
223: first support member
224: second support member
250: gearbox
251: motor
270: housing
500: wireless communication apparatus'supporter
510: fixing unit
530: body unit
560: bracket unit
610: rotation unit
611: cradling portion
612: first surface
613: second surfaces
614: slope
616: hole
620: rotation plate
621: sliding portions
630: elastic ring
680: bolt

1. A supporter for fixing a wireless communication apparatus to a support pole, the supporter comprising:
a fixing unit having one end fixed to the support pole;
a body unit connected to an other end of the fixing unit and including a rotation unit rotated by a motor;
a bracket unit that is connected to the rotation unit, rotatable about the rotation unit, and connected to the wireless communication apparatus; and
an elastic member configured to absorb shock,
wherein the rotation unit has one side formed with a reception groove,
wherein the bracket unit has one side formed with a protrusion portion that is disposed inside the reception groove and conforms to the reception groove, and
wherein the elastic member is disposed between the reception groove and the protrusion portion.

2. The supporter for a wireless communication apparatus of claim 1, wherein the protrusion portion is configured to move by an external force, and when moved and then relieved from the external force, to return by an elastic force of the elastic member to an original position that is a position of the protrusion portion before the external force was applied.

3. The supporter for a wireless communication apparatus of claim 1, wherein the protrusion portion includes a hexagonal column.

4. The supporter for a wireless communication apparatus of claim 3, wherein the hexagonal column has cross-sections including a perpendicular cross-section to a lengthwise direction of the hexagonal column, the perpendicular cross-section having areas that are linearly increasing or decreasing along the lengthwise direction.

5. The supporter for a wireless communication apparatus of claim 3, wherein the elastic member has one surface that is hexagonal conforming to the hexagonal column.

6. The supporter for a wireless communication apparatus of claim 5, wherein the elastic member includes a plurality of extension portions extending from an one surface thereof.

7. The supporter for a wireless communication apparatus of claim 6, wherein the plurality of extension portions comprises:
a first extension portion through a sixth extension portion.

8. The supporter for a wireless communication apparatus of claim 6, wherein the plurality of extension portions each have an outer circumferential surface and an inner circumferential surface that is longer than the outer circumferential surface, and have a curved shape along a lengthwise direction.

9. The supporter for a wireless communication apparatus of claim 1, wherein the elastic member is made of a metallic material.

10. A supporter for a wireless communication apparatus to a pole, the supporter comprising:
a fixing unit having one end fixed to the pole;
a body unit connected to an other end of the fixing unit and including a rotation unit rotated by a motor;
a bracket unit that is connected to the rotation unit, rotatable about the rotation unit, and connected to the wireless communication apparatus;
elastic rings disposed inside the bracket unit and configured to absorb shock; and
bolts penetrating the bracket unit and the elastic rings,
wherein the rotation unit has one side formed with cradling portions,
wherein the bracket unit has one side formed with sliding portions that conform to the cradling portions and are disposed on the cradling portions, and
wherein the bolts are screw-coupled with the rotation unit.

11. The supporter for a wireless communication apparatus of claim 10, wherein the sliding portions are configured to slide away from the cradling portions by an external force, and when slid and relieved from the external force, to return by an elastic force of the elastic rings to original positions that are positions of the sliding portions before the external force was applied.

12. The supporter for a wireless communication apparatus of claim 10, wherein the cradling portions include a plurality of slopes, and
wherein the sliding portions are configured to slide along at least one of the plurality of slopes.

13. The supporter for a wireless communication apparatus of claim 12, wherein the plurality of slopes comprises:
a first slope through a sixth slope.

14. The supporter for a wireless communication apparatus of claim 10, wherein the elastic rings are made of a rubber material.
